(19) United States
(12) Patent Application Publication
(10) Pub. No.: US 2016/0004825 A1
(43) Pub. Date: Jan. 7, 2016

(54) ONTOLOGICAL MEDICAL CODING METHOD, SYSTEM, AND APPARATUS

(71) Applicant: VITALWARE, LLC, Yakima, WA (US)

(72) Inventors: Kerry MARTIN, Yakima, WA (US); David KARNES, Issaquah, WA (US); Victor SHARPE, Yakima, WA (US); Robert GOLD, Atlanta, GA (US); Jill WOLF, Desert Hot Springs, CA (US); Adrian SHOWALTER, Yakima, WA (US); Joseph NICHOLS, Seattle, WA (US)

(21) Appl. No.: 14/769,433

(22) PCT Filed: Feb. 20, 2014
(86) PCT No.: PCT/US14/17527

§ 371 Date: Aug. 20, 2015

Related U.S. Application Data
(63) Continuation of application No. 14/185,915, filed on Feb. 20, 2014.
(60) Provisional application No. 61/850,577, filed on Feb. 20, 2013.

(51) Int. Cl. G06F 19/00

(52) U.S. Cl. CPC G06F 19/327; G06F 19/3443; G06F 19/322

(57) ABSTRACT

Diagnosis and procedure terminology are ontologically organized according to context-based categories and medical concepts. The medical concepts are linked to aliases and medical codes used to document patient care. A user is guided to select and document additional medical concepts based on a medical concept dependency that has been created between certain medical concepts, some of which are required. A visual concept tree presents for user consideration all categories and medical concepts necessary to determine appropriate medical codes based on the disease, condition or injury in accordance with a ranking algorithm and user documentation preferences. Potential medical codes are also optionally presented for user consideration based on collected documentation and selected medical concepts.

### FIELD

This disclosure relates to medical documentation and coding, and more particularly, to methods, systems, and apparatus for clinical documentation using rapid determination of appropriate medical coding data based on medical concept interdependencies and ranking algorithms.

### BACKGROUND

Medical coding is a classification process used in the healthcare industry to describe a patient condition, injury, or disease and procedures performed to diagnose and treat a patient. Medical codes are identifiers used by a particular medical coding system to specify, catalog, report, and document medical care for a particular patient. Medical codes may represent different types of conditions, diagnostics, treatments, and other medical actions.

Medical codes are an integral part of the various health information management (HIM) systems adopted by governments, public/private healthcare organizations, and international health agencies for various purposes, including medical billing, epidemiological studies, health services research, medical resource analysis and reallocation, and public education. Unfortunately, because each medical coding system is developed with a different highly specialized purpose, there are currently no universal medical codes to allow each of these healthcare groups to directly exchange information. As such, a medical code used in one medical coding system is not valid in other medical coding systems and must be translated into a compatible medical code.

Regrettably, obtaining accurate medical codes, regardless of the medical coding system, is problematic. It is primarily the clinician who must document the patient condition, order diagnostic procedures and treat the patient. Early determination or refinement of medical codes helps the clinician guide the patient care process according to the care appropriateness policies defined by the provider and the patient's medical insurance. Unfortunately, for most hospital inpatient care, the medical coding process may be performed after the patient is already discharged from the hospital and/or after the attending physician has completed his or her clinical documentation in the patient record. Delay in medical coding can introduce inaccuracies into the medical record, whether by omission or addition of critical medical data.

Fortunately, quality measurement, cost management, care appropriateness strategies and other regulatory requirements seek to require earlier determination of medical codes to better guide the patient care process. For example, the Medicare and Medicaid Electronic Health Record (EHR) Incentive Programs provide a financial incentive for achieving “meaningful use” of certified EHR technology including achievement of health and efficiency goals.

One of the EHR Incentive Programs' core measurement objectives is to maintain an up-to-date problem list of current and active diagnoses. This problem list must use either ICD medical codes or SNOMED-CT medical codes. In October 2014, the preferred medical coding system used in the United States to describe diagnoses and inpatient procedures is transitioning from ICD-9-CM to ICD-10-CM and ICD-10-PCS. This transition means that healthcare providers are expanding the number of possible medical codes from a total of approximately 16,000 medical codes to over 155,000 medical codes. This tenfold increase in the number of codes introduces greater clinical specificity, which increases the medical documentation requirements and increases the complexity of the medical coding process. Accordingly, the healthcare industry is imminently faced with the daunting task of providing earlier determination of significantly more complex medical codes.

### BRIEF DESCRIPTION OF THE DRAWINGS

Various embodiments are illustrated in the accompanying drawings. Similar references in the drawings indicate similar elements. The accompanying drawings, however, do not limit the scope of the disclosure and should be considered in context with the written description and claims.

FIG. 1 illustrates a suitable operating environment for ontological medical coding systems in accordance with at least one embodiment.

FIG. 2 illustrates several components of a medical coding server with access to a medical datastore in accordance with at least one embodiment.

FIG. 3 illustrates several components of a medical datastore in accordance with at least one embodiment.

FIG. 4 illustrates a flow diagram of a medical search routine for the medical coding server shown in FIG. 2 in accordance with at least one embodiment.

FIG. 5 illustrates a flow diagram of a medical documentation routine for the medical coding server shown in FIG. 2 in accordance with at least one embodiment.

FIG. 6 illustrates a flow diagram of a medical diagnosis/procedure routine for the medical coding server shown in FIG. 2 in accordance with at least one embodiment.

FIG. 7 illustrates a flow diagram of a medical coding routine for the medical coding server shown in FIG. 2 in accordance with at least one embodiment.

FIG. 8 illustrates a series of communications between a client coding device and a medical server to ontologically identify a medical condition based on collected documentation in accordance with one embodiment.

FIG. 9 illustrates a series of communications between a client coding device and a medical server to identify a medical condition based on an updated list of related medical concepts in accordance with one embodiment.

FIG. 10 illustrates a series of communications between a client coding device and a medical server to identify a medical condition from a medical keyword in accordance with one embodiment.

FIG. 11 illustrates a screenshot showing ontological medical coding using a keyword search in accordance with one embodiment.

FIG. 12 illustrates a screenshot showing the ontological medical coding shown in FIG. 11 and at least one additional medical concept in accordance with one embodiment.

FIG. 13 illustrates a screenshot showing the ontological medical coding shown in FIG. 12 using additional medical concepts to further narrow search parameters in accordance with one embodiment.

FIG. 14 illustrates a screenshot showing the ontological medical coding shown in FIG. 13 identifying enough additional medical concepts to document a medical condition in accordance with one embodiment.

FIG. 15 illustrates a screenshot showing ontological medical coding using a complex medical concept keyword in accordance with one embodiment.

FIG. 16 illustrates a screenshot showing ontological medical coding using a complex medical concept to document a medical condition in accordance with one embodiment.

### DETAILED DESCRIPTION

In accordance with various embodiments, an ontological medical coding service may provide users with rapid medical code determination based on selection of relevant medical concepts presented to the user in accordance with identified medical concept interdependencies, ranking algorithms, and user preferences. Medical facts may be received from a clinician or patient health record in the form of medical keywords. These medical keywords may be used to initiate a medical code search request. The medical coding service identifies matches between the medical search request and relevant medical concepts. The service may also identify the set of medical codes that implicitly or explicitly include the medical facts from the medical code search request. The service determines, generates, and presents a list with at least one potentially relevant medical category associated with the matching medical concept. Each listed medical category having another medical concept that if selected would serve to shorten the list of possible medical codes. The service can receive medical concept selections from the generated list until a medical code is designated. Optionally, the service may generate a potentially relevant medical code list based on matching medical concepts. The generated medical code list includes at least two medical codes that the user may directly designate as the desired medical code. In one embodiment, whenever the generated medical code list only has one medical code that medical code is automatically designated. Similarly, whenever a medical concept selection by a user results in only a single remaining medical code that medical code is automatically designated. VitalWare LLC (http://www.vitalware.com) provides commercial iDocuMint™ services (http://www.iDocuMint.com) based on Sherpa™ technology that includes one embodiment of such an ontological medical coding service.

The detailed description that follows is represented largely in terms of processes and symbolic representations of operations by conventional computer components, including a processor, memory storage devices for the processor, connected display devices and input devices. Furthermore, these processes and operations may utilize conventional computer components in a heterogeneous distributed computing environment; including remote file servers, computer servers, publishing resources, and/or memory storage devices. Each of these conventional distributed computing components is accessible by the processor via a communication network. In a heterogeneous distributed computing environment, clients, servers, and client/servers may be, for example, mainframes, minicomputers, workstations, or personal computers. Most services in a heterogeneous distributed computing environment can be grouped into one of these major categories: distributed file system, distributed computing resources, and messaging. A distributed file system provides a client with transparent access to part of the mass storage of a remote network device, such as a server. Distributed computing resources provide a client with access to computational or processing power of remote network devices, such as a cloud server. In one embodiment, distributed computing resources also provide a client with access to remote resources, such as printing/publication assets or data storage associated with remote network devices.

The phrases “in one embodiment,” “in various embodiments,” “in some embodiments,” and the like are used repeatedly. Such phrases do not necessarily refer to the same embodiment, but they may unless the context dictates otherwise. The terms “comprising,” “having,” and “including” are synonymous, unless the context dictates otherwise. The terms “match” and “matching” as used within this description do not necessarily refer to exactly equivalent unless the context dictates otherwise, but they may. More often the terms “match” and “matching” are referring to finding, identifying, word stemming, medical synonyms, contextual similarities, and the like relative to potential associations of related medical concepts found, identified, roughly equivalent, essentially equivalent, unless the context dictates otherwise. The term “medical concept” as used within this description refers to medical terminology describing medical terms, principles, conditions, treatments, and their aliases. These medical concepts are organized into a medical ontology of medical data accessible directly via medical keywords or indirectly via medical categories providing groupings of related medical concepts. The term “medical coding” as used in this description typically refers to a process of transforming descriptions of medical diagnoses and procedures into a more universal medical code. The patient's medical diagnoses and procedures might be taken from a variety of source documents that typically make up a patient's health record including transcriptions of the physician's notes, laboratory results, radiologic results, and other health care record sources. Examples of medical coding systems, which are used by health and clinical informatics as a health care classification system, include International Statistical Classification of Diseases and Related Health Problems (ICD), Current Procedural Terminology (CPT®), Health Care Procedure Coding System (HCPCS), Systematized Nomenclature of Medicine (SNOMED), Logical Observation Identifiers Names and Codes (LOINC), National Drug Code (NDC), Medical Subject Headings (MeSH), Unified Medical Language System (UMLS), Ambulatory Payment Classification (APC), Diagnosis Related Group (DRG), Local Coverage Determination/National Coverage Determination (LCD/NCD), Revenue Codes, Modifiers, and other similar coding systems used by the medical industry for classification.

Reference is now made in detail to the description of the embodiments as illustrated in the drawings. Particular embodiments described in this application provide specific case implementations of ontological medical coding by medical keywords, medical eponyms, medical synonyms and other complex medical concepts. While embodiments are described in connection with the drawings and related descriptions, there is no intent to limit the scope to the embodiments disclosed herein. On the contrary, the intent is to cover all alternatives, modifications, and equivalents. In alternate embodiments, additional devices, or combinations of illustrated devices, may be added to, or combined, without limiting the scope to the embodiments disclosed herein.

Various aspects of the illustrative embodiments will be described using terms commonly employed by those skilled in the art to convey the substance of their work to others skilled in the art. However, the embodiments described herein may be practiced with only some of the described aspects. For purposes of explanation, specific numbers, materials, and configurations may be set forth to provide a thorough understanding of the illustrative embodiments. However, the embodiments described herein may be practiced without the specific details. In other instances, well-known features are omitted or simplified in order not to obscure the illustrative embodiments.

Further, various operations and/or communications may be described as multiple discrete operations and/or communications, in turn, in a manner that may be helpful in understanding the embodiments described herein; however, the order of description should not be construed as to imply that these operations and/or communications are necessarily order dependent. In particular, these operations and/or communications need not be performed in the order of presentation.

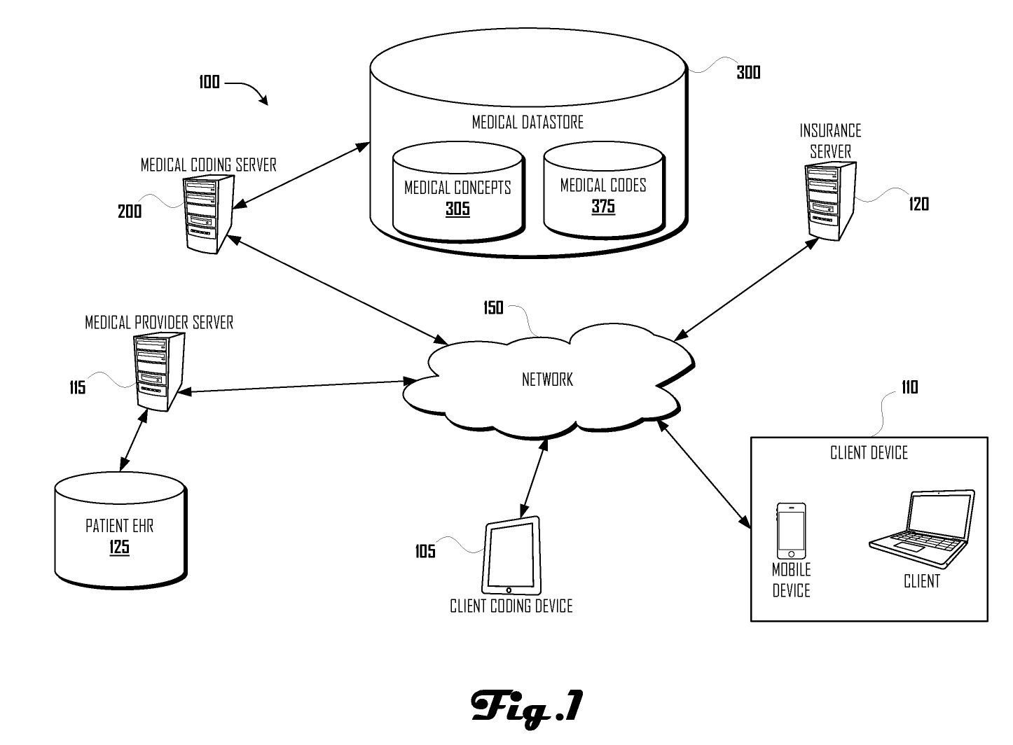

Referring now to FIG. 1, a suitable operating environment 100 for ontological medical coding systems is shown in accordance with at least one embodiment. The environment 100 may include a client coding device 105 or client device 110 coupled via a communications network 150 to a medical coding server 200. The medical coding server having access to a medical datastore 300 including medical concepts 305 and medical codes 375. In one embodiment, the client coding device 105, client device 110, and/or medical coding server 200 are in communication with a medical provider server 115 and/or an insurance server 120. The medical provider server 115 having access to patient health records, including patient electronic health records (EHR) 125.

Client coding device 105 and client device 110 may be any of a great number of mobile client devices capable of communicating with the communications network 150 and obtaining medical concept 305 and medical codes 375, for example, a personal tablet, a handheld computer, a cell phone, a personal game console, or any other suitable mobile device. However, Client coding device 105 and client device 110 need not be a mobile device. In some embodiments, some or all of the systems and methods disclosed herein may also be applicable to non-mobile client devices, such as a personal computer, a set-top box, television, and the like.

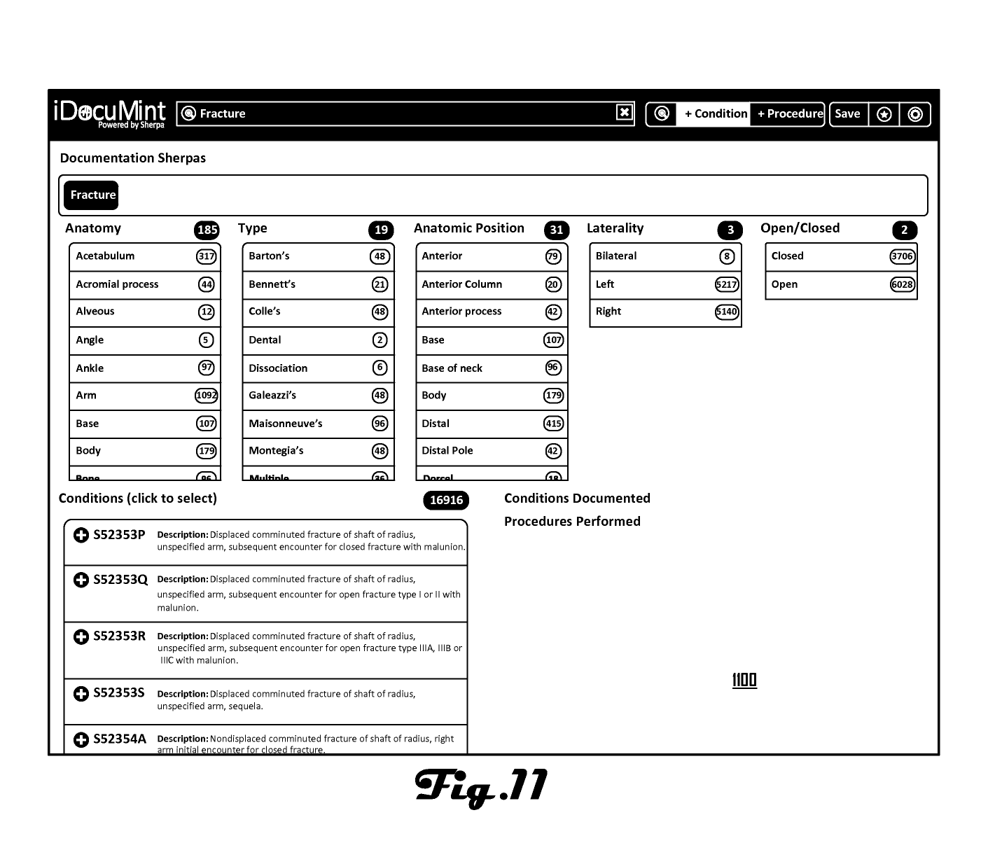

The communications network 150, as used herein, refers to a group of computers and associated devices that are connected by communication. Network communication may include a variety of connection types including hard wired connections, intermittent switched connections, or wireless connections. The size of a particular computer network may also vary from a local area network (“LAN”) with a few local computers, network devices, and other resources to a wide area network (“WAN”) interconnecting devices and networks across a larger geographic area. A popular collection of multiple interconnected networks is the internet, which when capitalized as “Internet” refers to the specific collection of networks and routers communicating using an Internet Protocol (“IP”) including several higher level communication protocols, such as Transmission Control Protocol/Internet Protocol (“TCP/IP”) or the Uniform Datagram Packet/Internet Protocol (“UDP/IP”). As the Internet has grown, so too has a document distribution system, commonly referred to as the World Wide Web (“WWW” or “web”), which electronically enables the delivery of hypertext documents at websites throughout the Internet to network devices and users. In view of the web becoming such a popular method of supplying and collecting information, one embodiment is described below that uses a web based client/server configuration. Accordingly, screenshots are used to illustrate a user interface for at least one embodiment of an ontological medical coding service. More specifically, screenshots (see e.g., FIGS. 11-16, discussed below) show portions of the iDocuMint™ medical coding services (http://wwwiDocuMint.com) based on Sherpa™ technology provided by VitalWare LLC (http://www.vitalware.com).

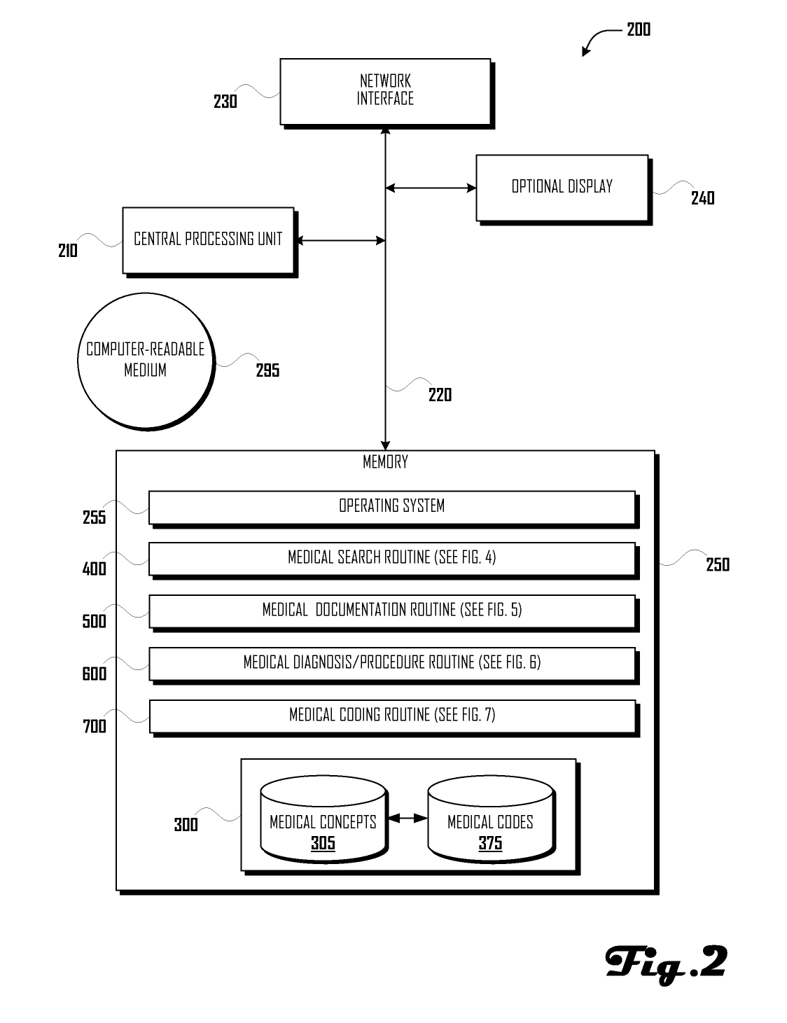

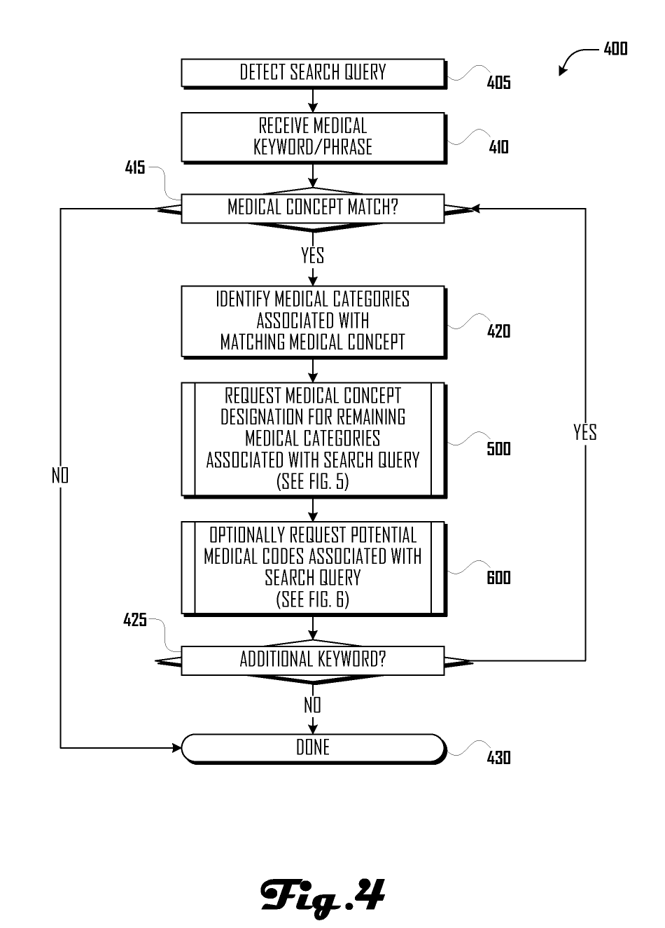

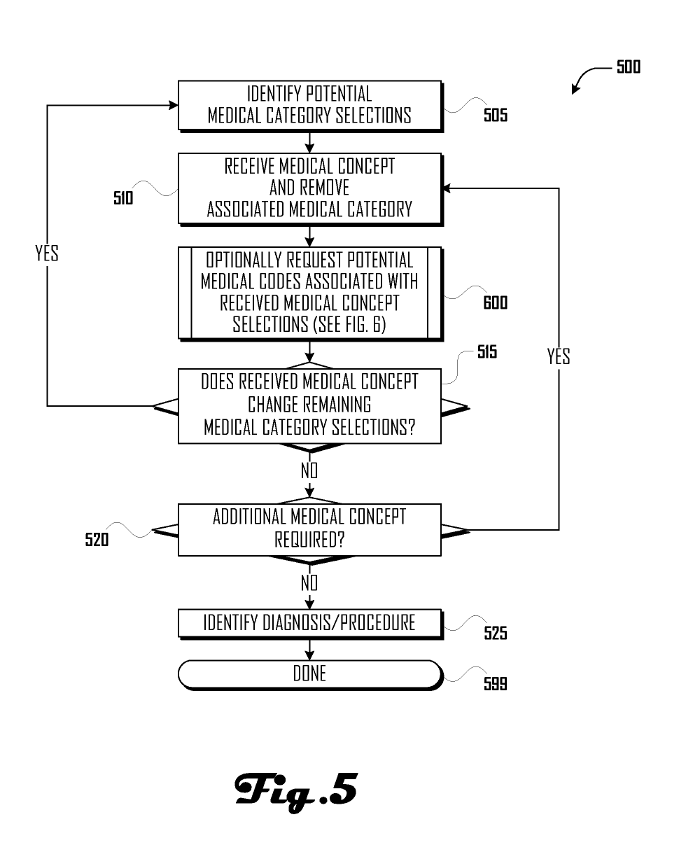

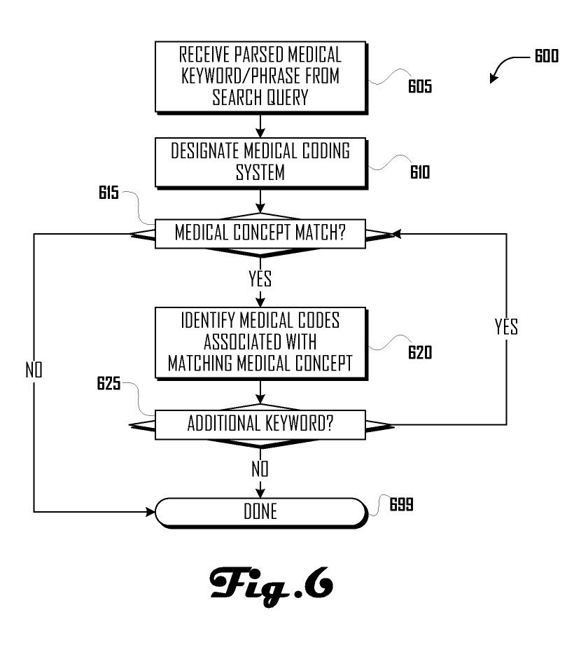

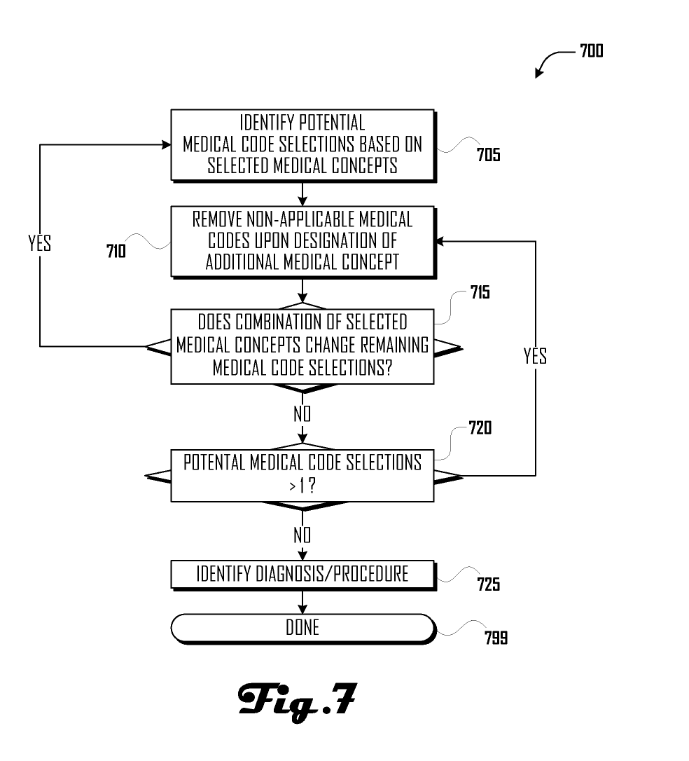

Referring now to FIG. 2, several components of a medical coding server 200 with access to a medical datastore 300 are shown in accordance with at least one embodiment. In some embodiments, the medical coding server 200 may include many more components than those shown in FIG. 2. However, it is not necessary that all of these generally conventional components be shown in order to disclose an illustrative embodiment. As shown in FIG. 2, the medical coding server 200 includes a network communication interface 230 for connecting to the communications network 150. The medical coding server 200 also includes a processing unit 210 with one or more processors, a memory 250, and an optional display interface 240, all interconnected along with the network communication interface 230 via a communication bus 220. The memory 250 generally comprises a random access memory (“RAM”), a read only memory (“ROM”), and a permanent mass storage device, such as a disk drive, flash device, or the like. The memory 250 stores program code for a number of applications, which includes executable instructions for an ontological medical search routine 400 (see FIG. 4, discussed below), medical documentation routine 500 (see FIG. 5, discussed below), medical diagnosis/procedure routine 600 (see FIG. 6, discussed below), and medical coding routine 700 (see FIG. 7, discussed below). In one embodiment, the memory 250 may also store a medical datastore 300 including a database of medical concepts 305 and a database of medical codes 375. In addition, the memory 250 also stores an operating system 255. These software components may be loaded from a computer readable storage medium 295 into memory 250 of the medical coding server 200 using a read mechanism (not shown) associated with a non-transient computer readable storage medium 295, such as a floppy disc, tape, DVD/CD-ROM drive, memory card, or the like. In some embodiments, software components may also be loaded via the network communication interface 230, rather than via a computer readable storage medium 595.

Although a particular medical coding server 200 has been described that generally conforms to conventional general purpose computing devices, the medical coding server 200 may be any of a great number of network devices capable of communicating with the communications network 150 and obtaining applications, for example, mainframes, minicomputers, workstations, personal computers, or any other suitable computing device. In some embodiments, some or all of the systems and methods disclosed herein may also be applicable to distributed network devices, such as cloud computing, and the like. Available cloud resources may include applications, processing units, databases, and file services. In this manner, the medical coding server 200 enables convenient, on-demand network access to a shared pool of configurable ontological medical coding search, recommendation, documentation, designation and recordation related computing services and resources (e.g., networks, servers, storage, applications, and services) that can be rapidly provisioned and released with minimal management effort or service provider interaction. These services may be configured so that any computer connected to the communications network 150 is potentially connected to the group of ontological medical coding applications, processing units, databases, and files or at the very least is able to submit medical search requests, medical concept selections, and/or medical code designation. In this manner, the data maintained by ontological medical coding server 200 and/or medical datastore 300 may be accessible in a variety of ways by various client coding devices 105 and client devices 110, for example, a digital tablet, a personal computer, a portable scanner, a handheld computer, a cell phone, or any other device that is capable of accessing the communication network 150.

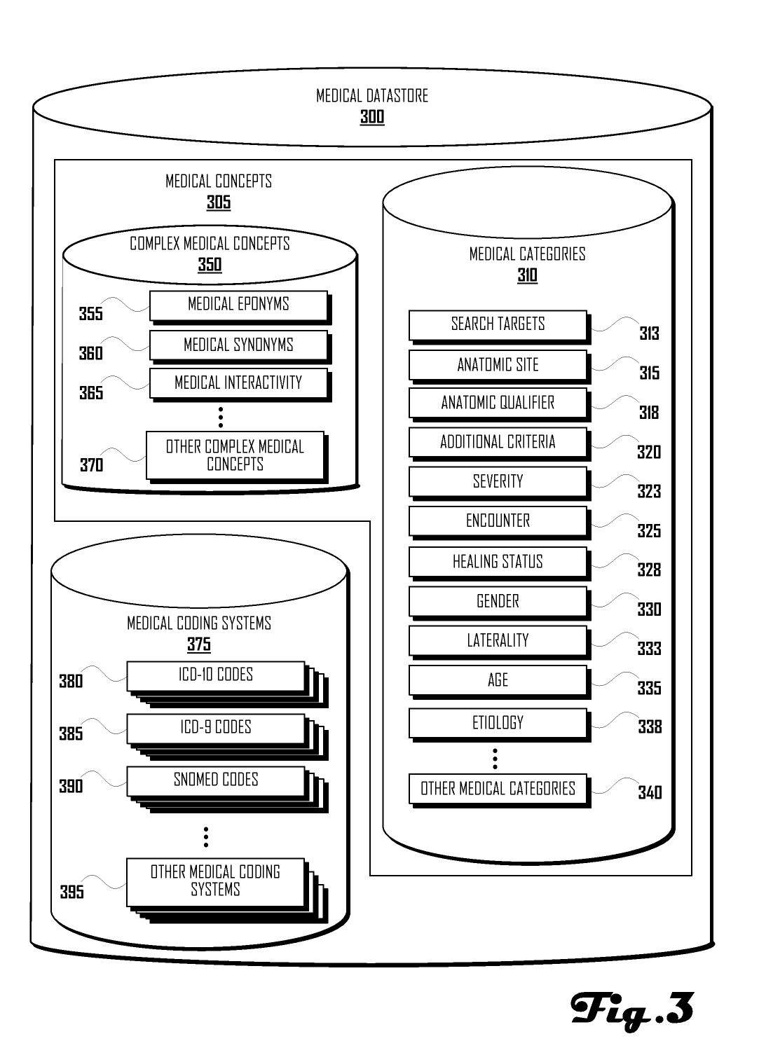

Referring now to FIG. 3, several components of a medical datastore 300 are shown in accordance with at least one embodiment. The medical datastore 300 includes one portion providing a database of medical concepts 305 and second portion providing a database of medical coding systems 375. The database for the medical concepts 305 includes at least two portions that identify different medical concept interdependencies, namely a database portion of medical categories 310 and a database portion of complex medical concepts 350. The database portion for medical categories 310 includes portions dedicated to identifying medical concept interdependencies according to search targets 313, anatomic site 315, anatomic qualifier 318, additional criteria 320, severity 323, encounter 325, healing status 328, gender 330, laterality 333, age 335, etiology 338, and other medical categories 340 that help define existing interdependencies between particular medical concepts that can be observed, collected, or documented by a clinician user relative to a set of medical codes from a desired target medical coding system. The database portion for complex medical concepts 350 includes portions dedicated to identifying medical concept interdependencies according to medical eponyms 355, medical synonyms 360, medical interactivity 365, and other complex medical concepts 370 that help designate particular medical codes based on interdependencies between particular medical keywords and various medical concepts.

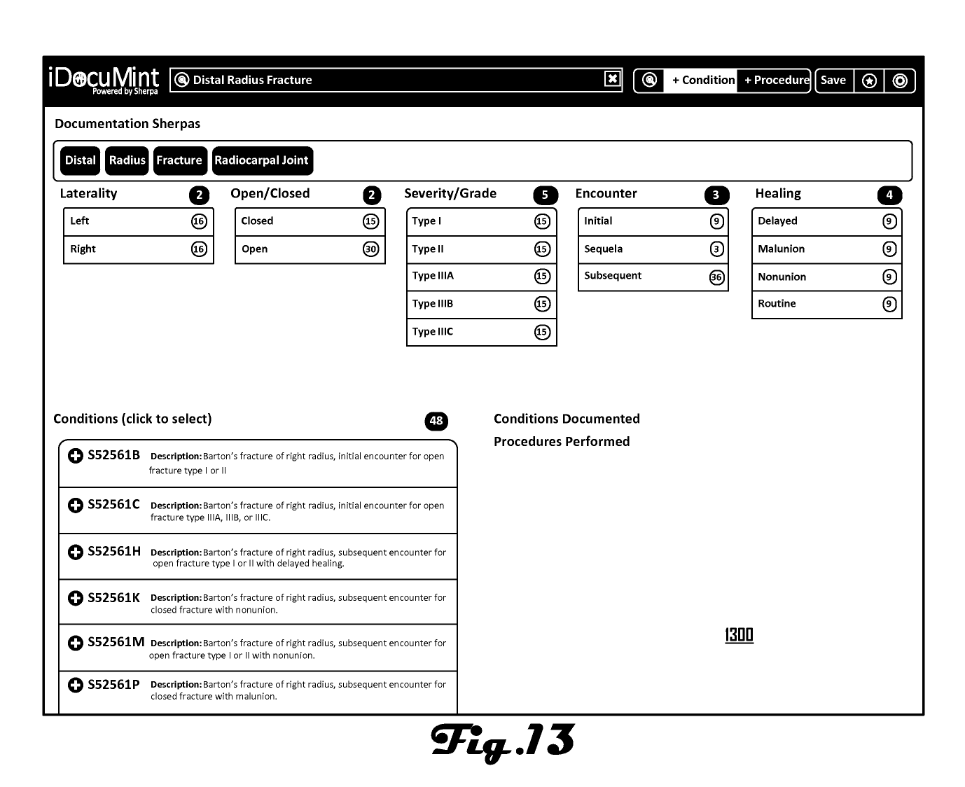

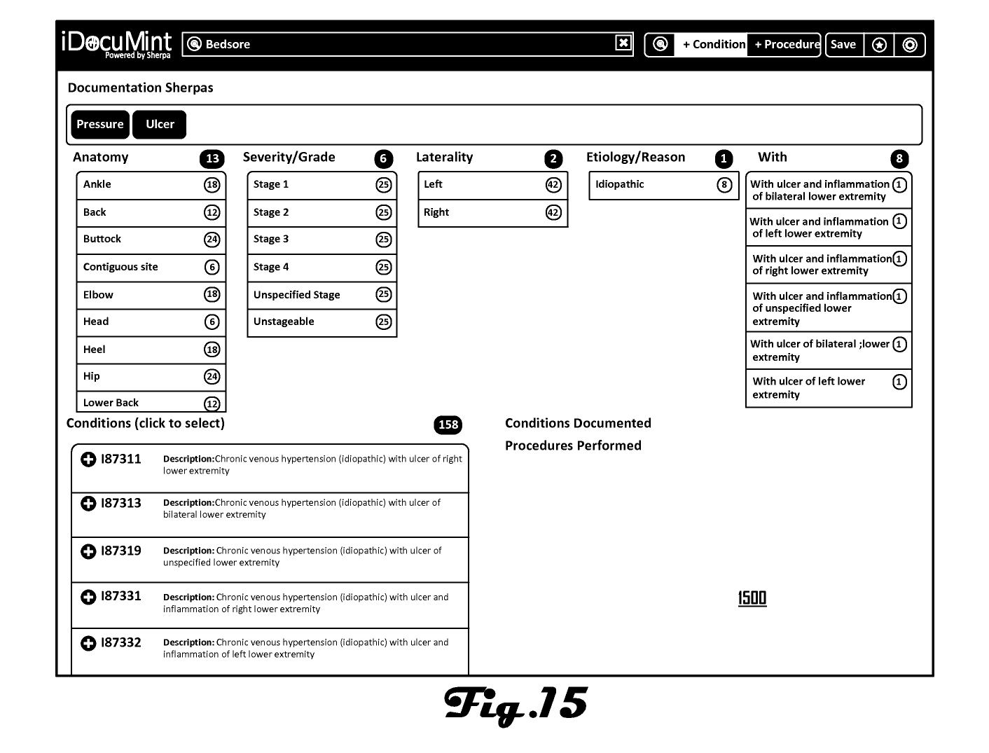

The scope of the medical ontology found within the medical datastore 300 includes medical concepts which are contained in the meanings of the target medical codes of medical coding systems. Thus, each medical concept may be grouped into at least one medical category that helps to provide additional clinical context to medical concepts associated with the medical category. For example, some medical categories shown in screenshots described below include Laterality and Severity. Each medical category contains medical concepts that may be part of the meaning of one or more medical codes and are linked to medical codes that contain the medical concept. For example, the Laterality medical category includes Left and Right medical concepts and the Severity medical category includes various stages (see e.g., medical concepts: Stage 1, Stage 2, Stage 3, Stage 4, unspecified stage, and unstageable shown under medical category Severity/Grade in FIG. 15) or types (see e.g., medical concepts: Type I, Type II, Type IIIA, Type IIIB, and Type IIIC shown under medical category Severity/grade in FIG. 13) as related medical concepts. The medical coding server 200 determines which set of medical concepts should be displayed for a particular medical category based in part on medical keywords in the medical search. The medical coding server 200 also considers identified medical concept interdependencies, ontological ranking algorithms, and user preferences prior to displaying related medical categories to the requesting user. Medical concepts can also include medical eponyms 355, medical synonyms 360, medical term interactivity 365 (i.e., medical abbreviations, medical acronyms, and other medical relational dependencies), so that the initial selection of “where to start” provided in a search request identifies appropriate medical concepts in the ontology. In one embodiment, to improve conceptual understanding by the user selecting the search terms and also to satisfy best practice documentation and coding process restrictions; additional clarification content (e.g., concept help information) can be viewed for each medical concept and medical code.

In one embodiment, the ontological ranking algorithm sorts relevant medical categories according to clinical diagnostic preference to preferentially show items in an order corresponding to preferred medical diagnostic process. In one embodiment, the ontological ranking algorithm sorts relevant medical categories according to mathematical efficiency in an effort to suggest medical concepts that will designate a medical code with a minimal number of medical concept selections. In one embodiment, the ontological ranking algorithm sorts relevant medical categories according to quantitative ranking to show medical categories having the most/least potential medical concepts. In one embodiment, the ontological ranking algorithm sorts relevant medical categories according to personal clinician preference ranking to preferentially show medical categories in the order frequently used by the particular clinician. In various embodiments, evaluating relative effectiveness of various ontologically ranking methodologies allow a medical coding server 200 to improve user satisfaction and overall efficiency.

The second portion of the medical datastore 300 provides a database of different medical coding systems 375 including ICD-10 medical codes 380, ICD-9 medical codes 385, SNOMED-CT medical codes 390, and medical codes associated with other medical coding systems 395. These other medical coding systems 395 may includes different medical coding systems offered by International Statistical Classification of Diseases and Related Health Problems (ICD) (e.g. ICD-11 codes), Current Procedural Terminology (CPT®), Health Care Procedure Coding System (HCPCS), Systematized Nomenclature of Medicine (SNOMED), Logical Observation Identifiers Names and Codes (LOINC), National Drug Code (NDC), Medical Subject Headings (MeSH), Unified Medical Language System (UMLS), Ambulatory Payment Classification (APC), Diagnosis Related Group (DRG), Local Coverage Determination/National Coverage Determination (LCD/NCD), Revenue Codes, Modifiers, and/or other similar coding systems used by the medical and/or healthcare industry for classification.

As previously discussed each medical coding system includes a unique set of required medical concept documentation before a particular medical code may be designated. As previously stated in 2014, the preferred medical coding system used in the United States to describe diagnoses and inpatient procedures is transitioning from ICD-9-CM to ICD-10-CM and ICD-10-PCS. This transition means that the number of possible medical codes is increasing from a total of approximately 16,000 medical codes to over 155,000 medical codes. In one embodiment, the described medical coding system allows individuals to collect pertinent medical concept data regardless of which medical coding system is designated and supplement documentation upon designation of a target medical coding system. Moreover, previously designated medical codes from an originating medical coding system may be translated back into the fundamental medical concepts and, where no additional information is necessary, translated into a target medical coding system.

Referring now to FIG. 4, a flow diagram, in accordance with at least one embodiment, shows a medical search routine 400 for the medical coding server 200 described previously in FIG. 2. As previously illustrated in FIG. 2, the memory 250 may store program code for the medical search routine 400 for identifying medical keywords, medical categories, medical concepts, and medical codes. Initially routine 400 detects a search query in block 405. In one embodiment, keystrokes are sent real-time to the medical coding server 200 from either the client coding device 105 or the client device 110 to initiate the medical search routine 400. Alternatively, portions of the datastore 300 may be maintained on the client coding device 105 or the client device 110 to facilitate local search functionality. Once a medical keyword/phrase is received in block 410, routine 400 matches the medical keyword/phrase with at least one medical concept in query block 415. If no match is found routine 400 ends in termination block 430, until the routine is reactivated by additional keyword activity. If a medical concept match is found in query block 415, routine 400 identifies medical categories associated with the matching medical concept in execution block 420. In one embodiment, routine 400 requests designation of at least one additional medical concept for each remaining medical category associated with the search query in subroutine block 500. In one embodiment, routine 400 may optionally request potential medical codes associated with the search query in subroutine block 600. Subsequently, routine 400 detects any additional keywords in query block 425 and returns to query block 415 to identify an additional medical concept match, if any. If no additional keywords are supplied, routine 400 ends in termination block 430.

Referring now to FIG. 5, a flow diagram, in accordance with at least one embodiment, shows a medical documentation routine 500 for the medical coding server 200 described previously in FIG. 2. Routine 500 identifies potential medical category selections in block 505. In one embodiment, these potential category selections may be identified based on identified medical concept interdependencies associated with the initial medical concept derived from the medical keyword in the search request. Upon receipt of a medical concept selection in block 510, routine 500 removes the medical category associated with the selected medical concept from the list of potential medical categories. In one embodiment, routine 500 optionally requests an updated list of potential medical codes associated with the received medical concept selections in subroutine block 600. Routine 500 determines whether the received medical concept changes the remaining potential medical category selections in query block 515. In one embodiment, selection of certain complex medical concepts requires modification of potential medical category selections based on interdependencies between the selected medical concepts and so routine 500 returns to execution block 505. Alternatively, when no additional changes to potential medical category selections are needed, routine 500 moves to query block 520. In query block 520, routine 500 determines whether selection and/or documentation of an additional medical concept is required. If addition information is needed, routine 500 returns to execution block 510. Otherwise, when no additional medical concepts are required, routine 500 automatically designates the remaining medical code identifying the diagnosis and/or procedure in block 525. After identifying the medical code, routine 500 ends in termination block 599.

Referring now to FIG. 6, a flow diagram, in accordance with at least one embodiment, shows a medical diagnosis/procedure routine 600 for the medical coding server 200 described previously in FIG. 2. Routine 600 receives a parsed medical keyword/phrase from a search query in block 605. In execution block 610, routine 600 designates a desired medical coding system. Routine 600 searches for matching medical concepts within the designated medical coding system in query block 615. If no match is found, routine 600 ends in termination block 699. Otherwise, routine 600 identifies medical codes associated with the matching medical concept in execution block 620. Query block 625 allows each additional keyword to be analyzed by returning routine 600 to query block 615. Once no additional keywords remain in the search query, routine 600 ends in termination block 699.

Referring now to FIG. 7, a flow diagram, in accordance with at least one embodiment, shows a medical coding routine 700 for the medical coding server 200 described previously in FIG. 2. Routine 700 identifies potential medical code selections based on selected medical concepts in execution block 705. In one embodiment, the list of potential medical codes is published to the user to enable direct designation of a particular medical code. Upon selection/designation of additional medical concepts, routine 700 removes non-applicable medical codes in execution block 710. In one embodiment, routine 700 determines in query block 715 whether the combination of selected medical concepts change availability of remaining potential medical code selections. If changes are made, routine 700 returns to execution block 705 to identify remaining potential medical code selections. Otherwise routine 700 continues to query block 720, where the number of potential medical code selections are evaluated. If there are still more than one remaining potential medical code selection routine 700 returns to block 710 to await addition designation of additional medical concepts. However, if there is only one remaining potential medical code selection, routine 700 identifies the diagnosis/procedure by designating the remaining potential medical code selection as the medical code in execution block 725. Upon identifying the medical code, routine 700 ends in termination block 799.

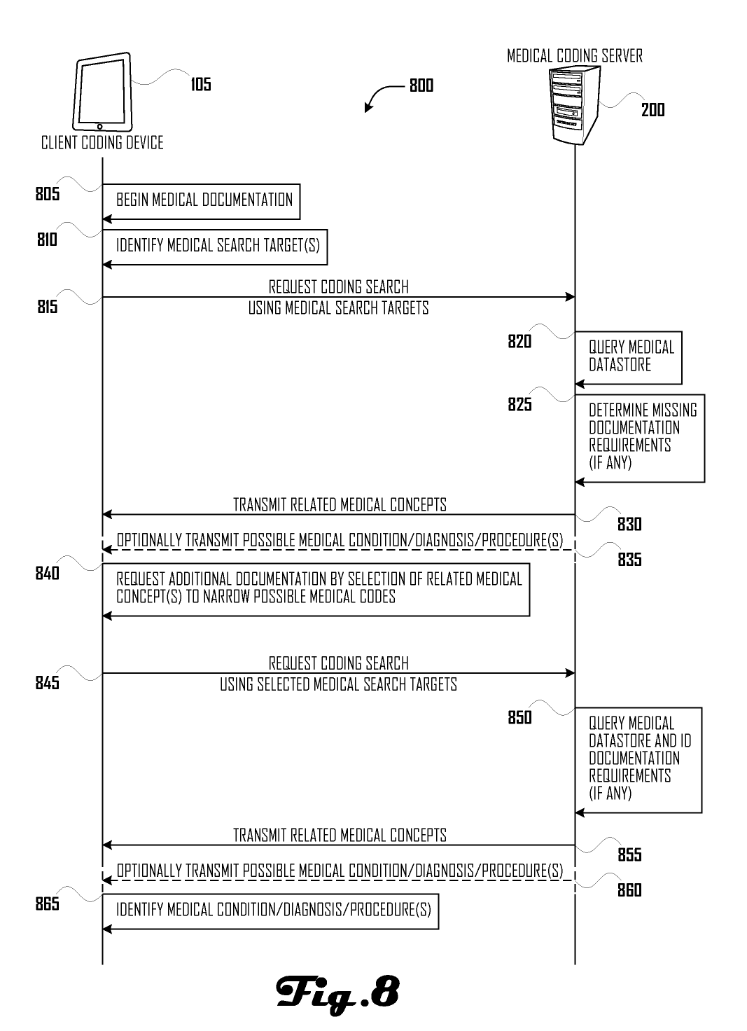

Referring now to FIG. 8, a series of communications between a client coding device 105 and a medical server 200 to ontologically identify a medical condition based on collected documentation are shown in accordance with one embodiment. The illustrated series of communications show one scenario in which the client coding device 105 identifies a medical condition and/or diagnosis and/or procedure based on medical concepts received from the medical coding server 200. The illustrated sequence of events is provided as an example for illustrative purposes. In other embodiments, a similar ontological medical coding process may be obtained via a different sequence of events.

Beginning the illustrated sequence of operations, client coding device 105 begins medical documentation 805, which may include actions where designating a medical code would be beneficial. For example, initiating a keyword search, review of an existing medical health record, or supplementing a patient record might all benefit from designation of a related medical code. Client coding device 105 identifies 810 at least one medical search target and requests 815 a medical coding search based on the at least one identified medical search target. Upon receiving the search request, medical coding server 200 queries 820 medical datastore 300. After identifying additional potential medical concepts needed, medical coding server 200 determines 825 missing documentation required, if any. The medical coding server 200 transmits 830 related medical concepts back to the client coding device 105 for supplemental documentation, if necessary. The medical coding server 200 may also optionally transmit 835 possible medical conditions and/or diagnosis and/or procedures to the client coding device 105 for direct selection by the user. Upon receipt of the related medical concepts, the client coding device 105 requests 840 additional documentation by user selection of related medical concepts. In one embodiment, each subsequent medical concept selection narrows the list of possible medical codes. Upon selection of related medical concepts, client coding device 105 requests 845 a medical coding search based on the selected search targets. Upon receiving the search request, medical coding server 200 queries 850 the medical datastore 300 using the selected medical search targets and identifies all remaining documentation requirements, if any. The medical coding server 200 transmits 855 related medical concepts back to the client coding device 105 for supplemental documentation, if necessary. The medical coding server 200 may also optionally transmit 860 possible medical conditions and/or diagnosis and/or procedures to the client coding device 105 for direct selection by the user. Upon receipt of the related medical concepts, the client coding device 105 identifies 865 a medical condition and/or diagnosis and/or procedure.

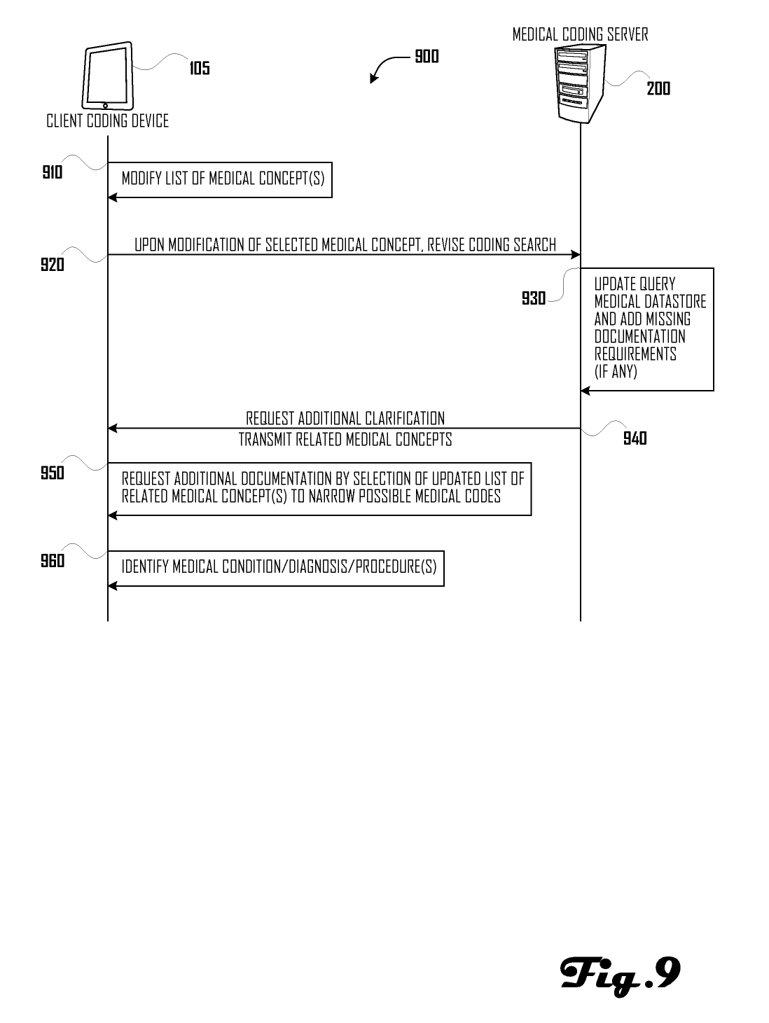

Referring now to FIG. 9, a series of communications between a client coding device and a medical server to identify a medical condition based on an updated list of related medical concepts are shown in accordance with one embodiment. As previously indicated, the illustrated series of communications show one scenario in which the client coding device 105 identifies a medical condition and/or diagnosis and/or procedure based on documented medical concepts received from the user. The illustrated sequence of events is provided as an example for illustrative purposes. In other embodiments, a similar ontological medical coding process may be obtained via a different sequence of events.

Beginning the illustrated sequence of operations, client coding device 105 begins by modifying 910 an existing list of medical concepts. In one embodiment, modification includes removal of a selected medical concept. In another embodiment, modification includes changing a selected medical concept. In yet another embodiment, modification includes addition of at least one medical concept. Upon modification, the client coding device 105 revises 920 a medical coding search. The medical coding server 200 updates 930 the query of the medical datastore 300 to add missing documentation requirements, if any, in light of the revised coding search. The medical coding server 200 requests 940 additional clarification, if needed, and transmits related medical concepts, if any. Subsequently, the client coding device 105 requests 950 additional document, if needed, by requesting user selection of any remaining related medical concepts from an updated list of medical concepts and/or medical codes to narrow the list of possible medical codes. Upon receipt of sufficient documentation or direct designation by a user of a medical code, the client coding device 105 identifies 960 a medical condition and/or diagnosis and/or procedure.

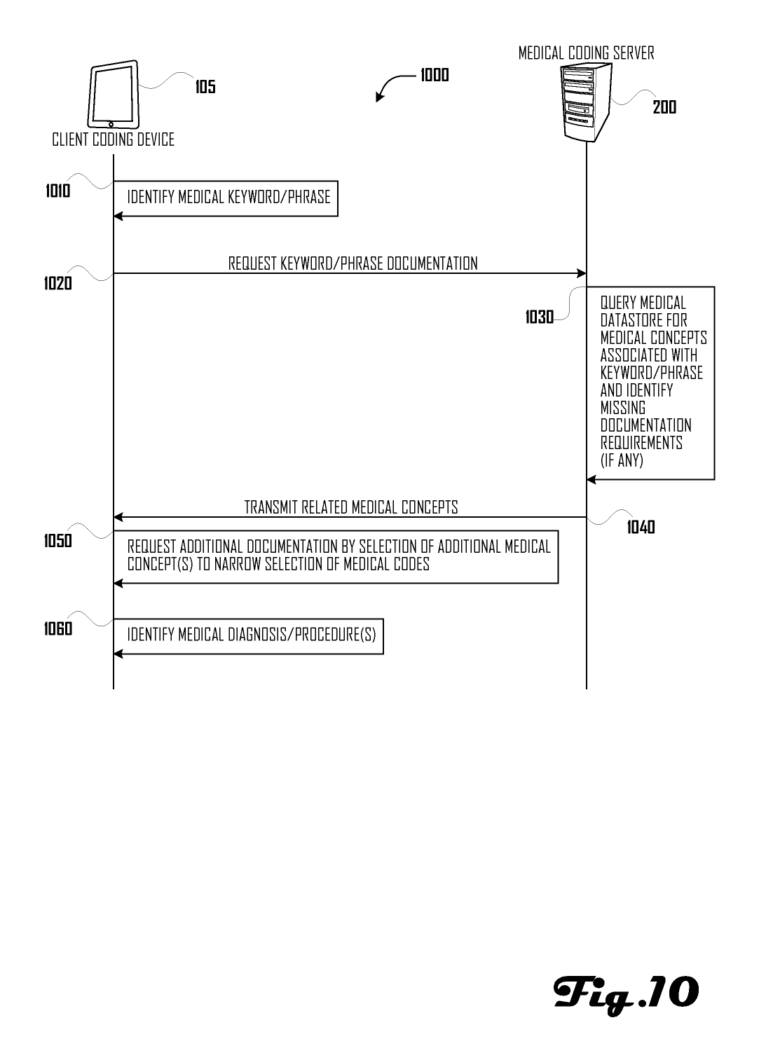

Referring now to FIG. 10, a series of communications between a client coding device and a medical server to identify a medical condition from a medical keyword are shown in accordance with one embodiment. As previously indicated, the illustrated series of communications show one scenario in which the client coding device 105 identifies a medical condition and/or diagnosis and/or procedure based on documented medical concepts received from the user. The illustrated sequence of events is provided as an example for illustrative purposes. In other embodiments, a similar ontological medical coding process may be obtained via a different sequence of events.

Beginning the illustrated sequence of operations, client coding device 105 begins by identifying 1010 a medical keyword/phrase. In one embodiment, medical keywords may include medical eponyms, synonyms, abbreviations, acronyms, homonyms, basionyms, anacronyms, anepronyms, hypernyms, hyponyms, isonyms, meronyms, metonyms, taxonyms, tautonyms, troponyms, toponyms, and other terms and or phrase that exhibit complex interactivity with at least one medical concepts. If necessary, the client coding device 105 requests 1020 keyword/phrase required documentation from medical coding server 200. The medical coding server 200 queries 1030 the medical datastore 300 for medical concepts associated with the keyword/phrase and identifies missing documentation requirements, if any. The medical coding server 200 transmits 1040 back to the client coding device 105 related medical concepts, if any. Subsequently, the client coding device 105 requests 1050 additional documentation, if needed, by requesting user selection of any additional medical concepts to narrow the selection of possible medical codes. Upon receipt of sufficient documentation and/or direct designation by a user of a medical code, the client coding device 105 identifies 1060 a medical condition and/or diagnosis and/or procedure.

Referring now to FIG. 11, a screenshot 1100 shows ontological medical coding using a keyword search in accordance with one embodiment. The screenshot 1100 shows a possible first step in a search process for a Barton's Fracture. The keyword search is for “Fracture” and has 16,916 matching ICD-10 codes. At least five medical categories are listed including Anatomy with 185 matching medical concepts, Type with nineteen matching medical concepts, Anatomic Position with thirty-one matching medical concepts, Laterality with three matching medical concepts, and Open/Closed has two matching medical concepts.

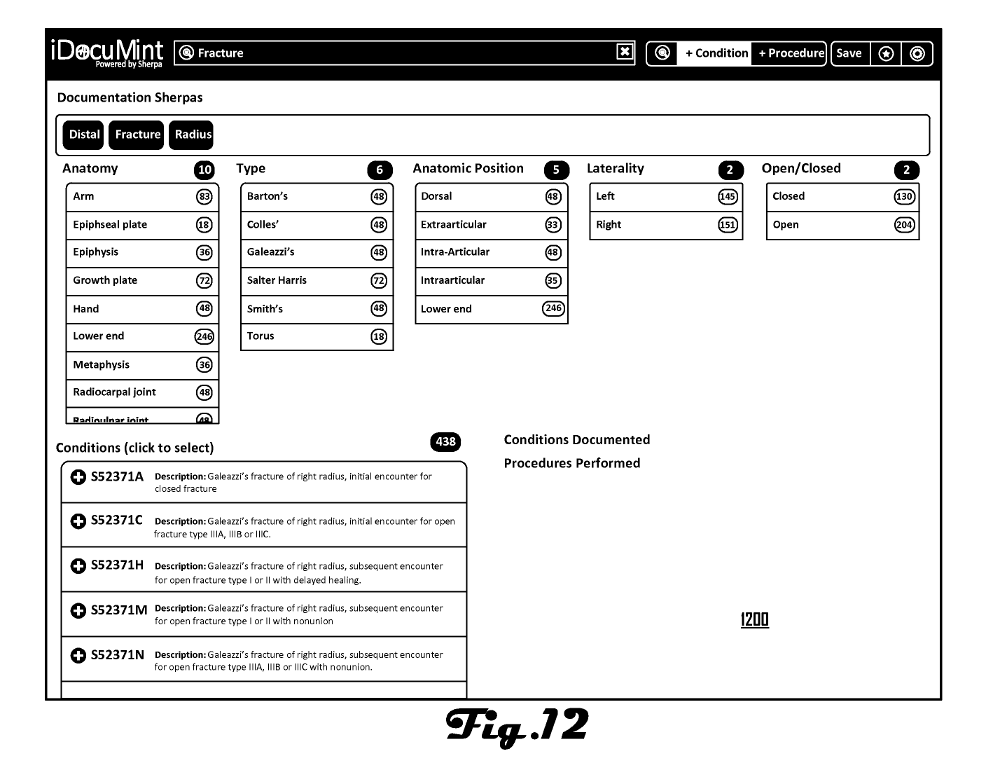

Referring now to FIG. 12, a screenshot 1200, in accordance with one embodiment, shows the ontological medical coding described previously in FIG. 11 and at least one additional medical concept. The screenshot 1200 shows a possible second step in a search process for a Barton's Fracture, in which additional medical concepts ‘Distal’ and ‘Radius’ are selected. This reduces the number of matching ICD-10 codes to 438. Under the medical category Type there are 6 different Eponyms (“named” fractures) listed.

Referring now to FIG. 13, a screenshot 1300, in accordance with one embodiment, shows the ontological medical coding, described previously in FIG. 12, further using additional medical concepts to further narrow search parameters. The screenshot 1300 shows a possible third step in a search process for a Barton's Fracture, in which the additional medical concept ‘Radiocarpal Joint’ is selected and added to the previous keyword ‘Fracture’ and selected medical concepts ‘Distal’ and ‘Radius’. This reduces the number of matching ICD-10 codes to 48.

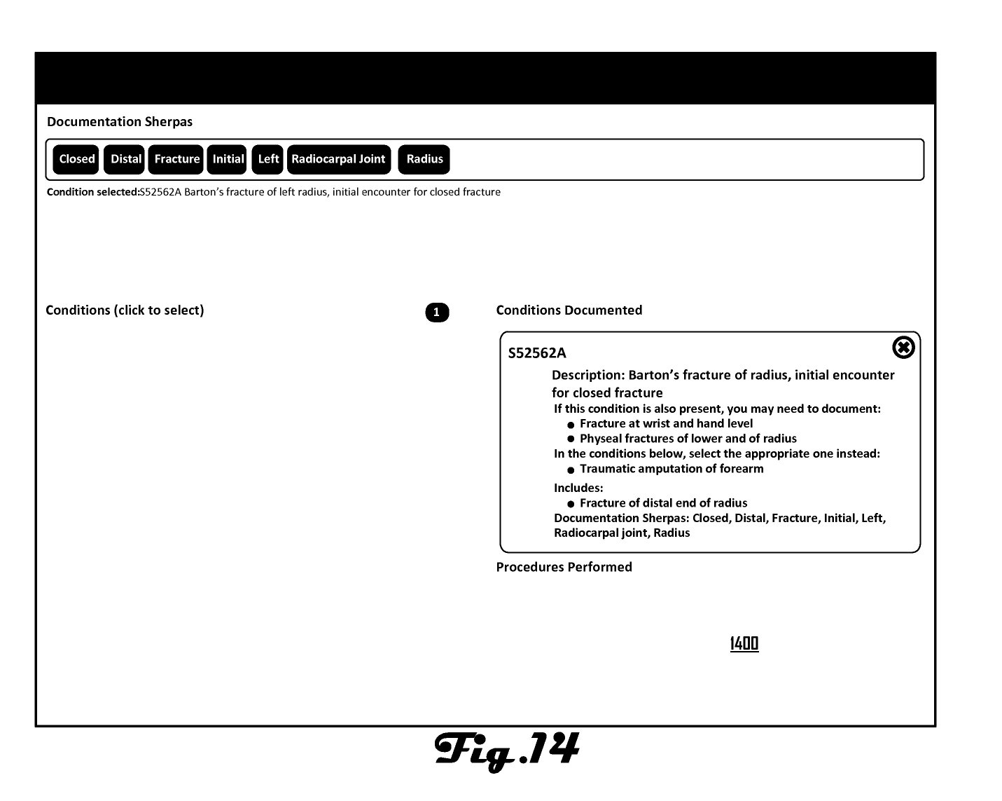

Referring now to FIG. 14, a screenshot 1400, in accordance with one embodiment, shows the ontological medical coding, described previously in FIG. 13, now identifying enough additional medical concepts to document a medical condition. The screenshot 1400 shows a possible fourth step in a search process for a Barton's Fracture, in which the additional medical concepts ‘Left’ ‘Initial’ and ‘Closed’ are selected and added to the previous keyword ‘Fracture’ and selected medical concepts ‘Radiocarpal Joint’, ‘Distal’, and ‘Radius’. This reduces the number of matching ICD-10 codes to 1, which allows the remaining condition S52562A to be automatically designated.

Referring now to FIG. 15, a screenshot 1500 shows ontological medical coding using a complex medical concept keyword in accordance with one embodiment. Screenshot 1500 shows of one example of a complex medical concept. User types in ‘bedsore’ in the search field and the iDocuMint™ ontological medical coding service matches that keyword phrase with different two medical concepts ‘pressure’ and ‘ulcer’. As such, according to the target medical coding system, the keyword phrase ‘Bedsore’ is synonymous with the medical concept combination of ‘pressure’ and ‘ulcer’ as shown in the selected medical concept list.

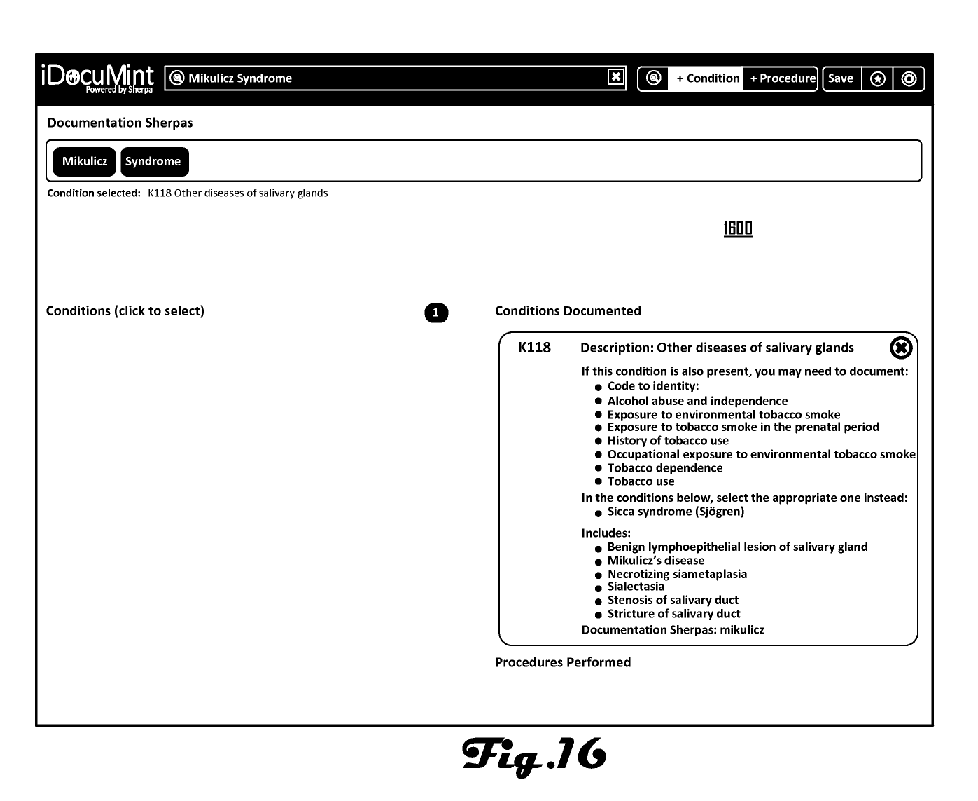

Referring now to FIG. 16, a screenshot 1600 shows ontological medical coding using a complex medical concept to directly document a medical condition in accordance with one embodiment. Screenshot 1600 shows that all necessary conditions are directly documented by the keyword phrase and/or selected medical concepts. More specifically ‘Mikulicz’ and ‘Syndrome’ as shown in both the search field and the selected medical concept field result in exactly one potential condition. This particular example also illustrates the results of searching multiple data sources (e.g., ICD-10-CM Alphabetical Index and ICD-10-CM) to identify the applicable medical code(s). In this particular case, the search request only applies to one code, K118, which was automatically selected by the application. This automatic designation occurs despite the fact that the keywords are not found in the description of the applicable code.

Although specific embodiments have been illustrated and described herein, a whole variety of alternate and/or equivalent implementations may be substituted for the specific embodiments shown and described without departing from the scope of the present disclosure. This application is intended to cover any adaptations or variations of the embodiments discussed herein.

1. A computer-implemented method to provide ontological medical coding, the method comprising:
receiving a medical search request including at least one medical keyword;
identifying a match between the medical search request and a medical concept;
generating a list with at least one potentially relevant medical category associated with the matching medical concept; each medical category having another medical concept; and
receiving at least one selection of at least one other medical concept from the generated list until a medical code is designated.

2. The computer-implemented method of claim 1, wherein the generating includes revising the generated list after each received selection of the at least one other medical concept to include any additional potentially relevant medical category associated with the received selection of the at least one other medical concept.

3. The computer-implemented method of claim 1, further comprising automatically designating a medical code based on the matching medical concept and any selected other medical concept(s) whenever there is not at least one potentially relevant medical category.

4. The computer-implemented method of claim 1, further comprising generating a potentially relevant medical code list based on the matching medical concept, the generated medical code list having at least one medical code.

5. The computer-implemented method of claim 4, further comprising designating a medical code from the generated medical code list.

6. The computer-implemented method of claim 1, wherein the medical code is selected from a designated medical coding system.

7. The computer-implemented method of claim 1, further comprising generating clinical information to be documented in an electronic health record based on the designated medical code.

8. The computer-implemented method of claim 1, further comprising generating a medical claim based on the designated medical code.

9. The computer-implemented method of claim 1, wherein the generating the list of at least one potentially relevant medical category includes adding any potentially relevant medical category directly associated with the designated medical code.

10. One or more non-transitory computer readable medium having a plurality of instructions stored thereon which, when executed by one or more processors, cause the one or more processors to perform a method, the method comprising:
receiving a medical search request including at least one medical keyword;
identifying a match between the medical search request and a medical concept;
generating a list with at least one potentially relevant medical category associated with the matching medical concept; each medical category having another medical concept; and
receiving at least one selection of at least one other medical concept from the generated list until a medical code is designated.

11. The one or more non-transitory computer readable medium of claim 10, wherein the generating includes revising the generated list after each received selection of the at least one other medical concept to include any additional potentially relevant medical category associated with the received selection of the at least one other medical concept.

12. The one or more non-transitory computer readable medium of claim 10, further comprising automatically designating a medical code based on the matching medical concept and any selected other medical concept(s) whenever there is not at least one potentially relevant medical category.

13. The one or more non-transitory computer readable medium of claim 10, further comprising generating a potentially relevant medical code list based on the matching medical concept, the generated medical code list having at least one medical code.

14. The one or more non-transitory computer readable medium of claim 13, further comprising designating a medical code from the generated medical code list.

15. An ontological medical coding system, comprising:
one or more processors; and
one or more non-transitory computer readable medium having a plurality of instructions stored thereon, which, when executed by the one or more processors, cause the system to perform a method, the method comprising:
receiving a medical search request, from a user on a remote device, including at least one medical keyword;
identifying a match between the medical search request and at least one medical concept;
generating a list with at least one potentially relevant medical category associated with the at least one matching medical concept; each medical category having at least one other medical concept;
receiving, from a user on a remote device, at least one selection of at least one additional medical concept from the generated list; and
designating a medical code based on the at least one matching medical concept and the selected at least one additional medical concept.

16. The ontological medical coding system of claim 15, wherein each medical concept is ontologically interdependent on at least one other potentially relevant medical category.

17. The ontological medical coding system of claim 15, wherein each medical concept represents a portion of documentation required to designate the medical code.

18. The ontological medical coding system of claim 15, wherein the designating the medical code includes obtaining documentation required for the medical code.

19. The ontological medical coding system of claim 15, wherein the designating includes automatically designating a medical code based on the combination of the matching medical concept and any selected other medical concept(s) whenever the combination satisfies the documentation requirements associated with the medical code.

20. The ontological medical coding system of claim 15, wherein the medical code is selected from a medical coding system, the medical coding system being selected from the group consisting of International Classification of Diseases and Related Health Problems (ICD), Current Procedural Terminology (CPT), Health Care Procedure Coding System (HCPCS), Systematized Nomenclature of Medicine (SNOMED), Logical Observation Identifiers Names and Codes (LOINC), National Drug Code (NDC), Medical Subject Headings (MeSH), Unified Medical Language System (UMLS), Ambulatory Payment Classification (APC), Diagnosis Related Group (DRG), Local Coverage Determination/National Coverage Determination (LCD/NCD), Revenue Codes, and Modifiers coding systems.

21. The ontological medical coding system of claim 15, wherein the medical search request is extracted from an electronic health record by the user on the remote device.

22. The ontological medical coding system of claim 15, wherein the generating the list includes ontologically ranking at least two potentially relevant medical categories associated with the at least one matching medical concept.
